(19) United States
(12) Patent Application Publication
(10) Pub. No.: US 2009/0071380 A1
(43) Pub. Date: Mar. 19, 2009

(54) Board for pasturage

(76) Inventor: Sheng-Jui Chen, Pyng-Jenn City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/902,101

(22) Filed: Sep. 19, 2007

(51) Int. Cl. A47B 85/06

(52) U.S. Cl. 108/12

(57) ABSTRACT

An improved board for pasturage includes pasturage equipments installed on a back side of a board body, a positioning slot and a leg positioning slot disposed at a pasturage equipment and a leg of the pasturage equipment respectively, cup slots and containing slots disposed on a front side and around the periphery of the board body, an embedding slot disposed at a position corresponding to front and back sides of four corners of the board body, male and female latches disposed on both lateral sides of the board body and engaged with each other, and water injecting holes disposed on a lateral side of the board body. The board for pasturage not only connects the pasturage equipment directly for its use, but also operates with a leg or a support pillar as a leisure table, a storage cabinet, a fence or a billboard. The applications are simple, convenient and diversified.

### BACKGROUND OF THE INVENTION

1. Field of the Invention

The present invention relates to an improved board for pasturage, and more particularly to a simple, convenient, easy-to assemble and easy-to-use board for pasturage, so that the improved board for pasturage can be combined with a related pasturage equipment directly for its use, or operated together with a leg or a support pillar for diversified functions of a leisure table, a storage cabinet, a fence or a billboard, and the improved board for pasturage complies with the requirements of actual applicability, ideality, and inventive step.

2. Description of the Related Art

In general, a conventional board for pasturage (such as a pig driving board) is usually made of a simple square board, such that when the board is used for driving animals, the board can prevent the animals from colliding and achieve the protection effect. The conventional board comes with a simple design of a square board, and its simple feature provides a single application only, and thus its function is relatively insufficient.

### SUMMARY OF THE INVENTION

The primary objective of the present invention is to overcome the shortcomings of the prior art by providing an improved board for pasturage, wherein the board body comprises a plurality of pasturage equipments disposed at a back side of the board body, and having a positioning slot disposed at a position corresponding to a pasturage equipment, such that the board for pasturage can be combined with various pasturage equipments for its operation, and provides convenient and diversified functions.

Another objective of the present invention is to provide an improved board for pasturage, wherein the board body comprises a plurality of leg positioning slots disposed on a back side of the board body for installing legs, and a plurality of cup slots and containing slots disposed on a front side and around the periphery of the board body, so that the board for pasturage can be used as a leisure table.

A further objective of the present invention is to provide an improved board for pasturage, wherein the board body comprises an embedding slot disposed separately at a position corresponding to the front and back side of four corners of the board body, and a support pillar connected separately to the embedding slots, so that the boards for pasturage can be stacked to form a storage cabinet.

Another further objective of the present invention is to provide an improved board for pasturage, wherein the board body comprises male and female latches disposed on both laterals sides of the board body and engaged with each other, and a water injecting hole disposed on a lateral side of the board body, such that the boards for pasturage can be connected serially by extending the legs and injecting water into the hollow accommodating portion of the board or operated independently as a billboard or a fence.

To make it easier for our examiner to understand the objectives, characteristics and effects of the present invention, a preferred embodiment with accompanying drawings are used for a detailed description of the invention as follows.

### BRIEF DESCRIPTION OF THE DRAWINGS

FIG. 1 is a schematic perspective view of a board body having a pasturage equipment and a leg installed at a back side of the board body in accordance with a preferred embodiment of the present invention;

FIG. 2 is an exploded view of FIG. 2;

FIG. 3 is a schematic perspective view of a board body and support pillars in accordance with a preferred embodiment of the present invention;

FIG. 4 is a schematic perspective view of a leg installed at a board body in accordance with a preferred embodiment of the present invention;

FIG. 5 is an exploded view of FIG. 4;

FIG. 6 is a planar view of legs extended at a board body as depicted in FIG. 4;

FIG. 7 is a planar view of legs folded at a board body as depicted in FIG. 4;

FIG. 8 is a planar view of a support pillar being embedded and coupled to front and back sides of a board body in accordance with the present invention;

FIG. 9 is a planar view of a board body with its legs extended to serve as a billboard in accordance with a preferred embodiment of the present invention;

FIG. 10 is a planar view of board bodies connected serially with each other in accordance with a preferred embodiment of the present invention;

FIG. 11 is a schematic view of legs being extended to serve as a leisure table or a desk in accordance with a preferred embodiment of the present invention; and

FIG. 12 is a schematic perspective view of legs being extended to serve as a multilayer storage cabinet in accordance with a preferred embodiment of the present invention.

### DETAILED DESCRIPTION OF THE PREFERRED EMBODIMENTS

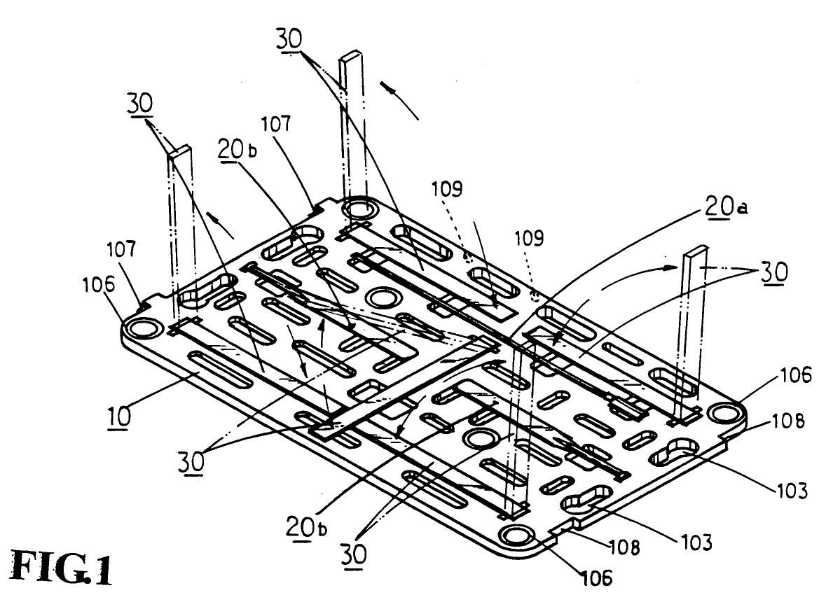

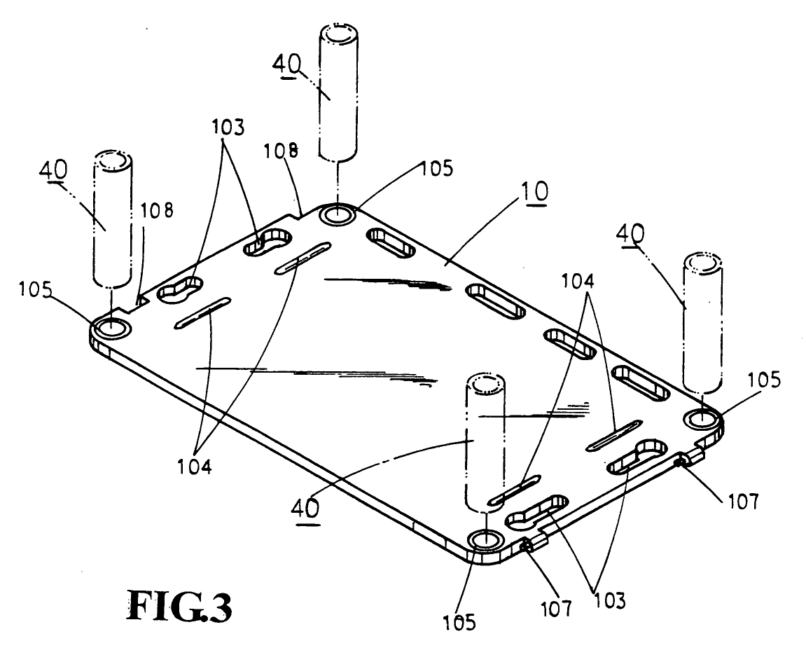

Referring to FIGS. 1 to 3, an improved board for pasturage in accordance with the present invention comprises a plurality of pasturage equipments disposed on a back side of a board body 10, having a positioning slot 101 and a leg positioning slot 102 embedded and coupled to a corresponding pasturage equipment 20 (such as an animal driving whip 20a, an animal driving racket 20b, an injection syringe, an artificial insemination tool and a flashlight, etc) and a leg 30; a plurality of cup slots 103 and containing slots 104 disposed on a front side and around the periphery of the board body 10 for disposing a cup and various stationeries; an embedding slot 105, 106 disposed separately at a position corresponding to front and back sides of four corners of the board body 10 for embedding and inserting a support pillar 40; male and female latches 107, 108 disposed on both lateral sides of the board body 10 and engaged with each other, such that the board bodies 10 can be connected serially; and a plurality of water injecting holes 109 disposed on a lateral side of the board body 10 for injecting water liquid when the board body 10 is set to its hollow condition.

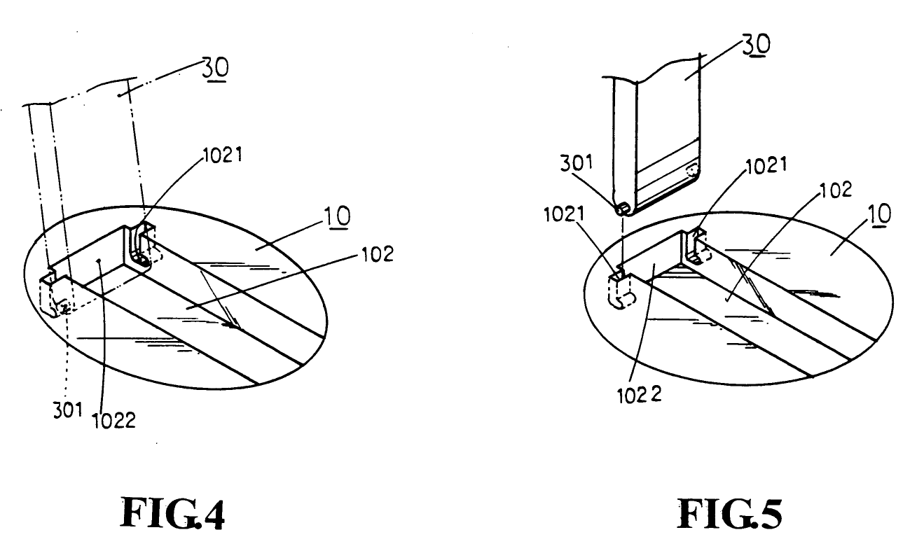

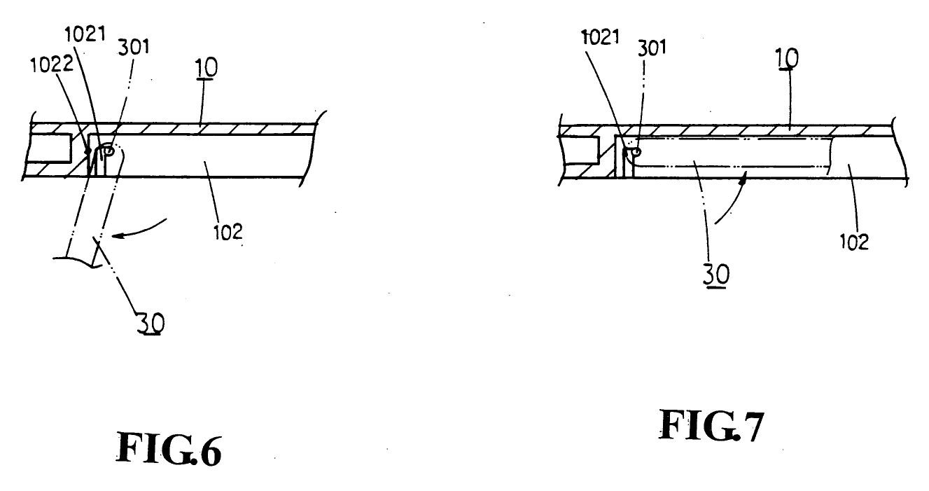

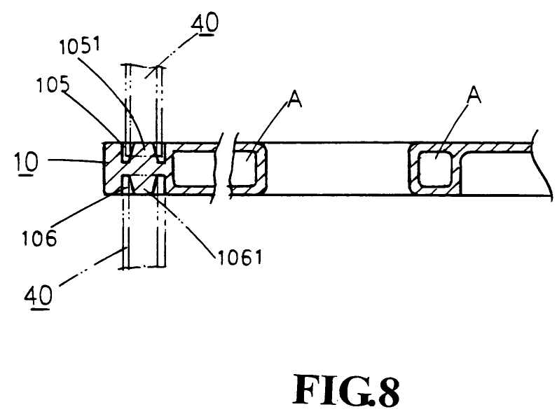

Referring to FIGS. 4 to 7, an end the leg 30 is swung up and down and installed pivotally to the board body 10, such that another end of the leg 30 is swung downward and extended into its erect position, or swung upward to fold and hide the leg 30 into a leg positioning slot 102, and the leg 30 of this embodiment includes a positioning pin 301 disposed separately on both lateral sides of an end of the leg 30, and a pin-in slot 1021 disposed separately on both lateral sides of an end of the leg positioning slot 102 of the board body 10 for pivotally coupling the leg positioning pin 301, such that after the positioning pin 31 of the leg 30 is slidably coupled to a pin-in slot 1021 of the board body 10, the leg 30 can be applied to the board body 10 and swung upward or downward for folding or extending the leg 30. Further, the pin-in slots 1021 on both lateral sides of the leg positioning slot 102 is installed proximate to an end surface 1022 of the leg positioning slot 102, such that when the leg 30 is erected and extended, the end surface 1022 of the leg positioning slot 102 is used for abutting the leg 30 slantingly (as shown in FIGS. 4 and 6).

Referring to FIG. 8, the board body 10 has the embedding slot 105, 106 disposed separately at a position corresponding to front and back sides of four corners of the board body 10 and set into various different form, and the embedding slot 105, 106 of a preferred embodiment has a conical joint 1051, 1061 disposed at the center of the embedding slot 105, 106 and tapered outward, for positioning support pillars 40 of different diameters. If the external diameter of the support pillar 40 is smaller than the embedding slot 105 or 106, and the internal diameter of the support pillar 40 is provided for inserting the conical joint 1051, 1061, then the conical joint 1051, 1061 can be used for abutting the internal diameter of the support pillar 40, such that the support pillar 40 is inserted naturally into the embedding slot 105, 106 with a secured positioning effect. In other words, the conical joint 1051, 1061 used together with the support pillar 40 can be made by easily available PVC pipes to provide a simple, easy and convenient effect. Further, the board body 10 of the invention can be made by a plastic injection molding to provide a hollow accommodating portion A, so that the require water liquid can be injected to the accommodating portion A through the water injecting hole 109 of the board body 10.

With the assembly of the present invention, the board body 10 can be a board used for driving animals (such as a pig driving board used in a pig house). Since various different pasturage tools can be installed directly into the corresponding pasturage tool positioning slots 101 on the back side of the board body 10, therefore when a user operates the board for pasturage, the user can combine different pasturage tools (such as a driving whip, a driving racket, an injection syringe, an artificial insemination, and a flashlight, etc) therein to achieve an application with a simple, easy, convenient and instant effect.

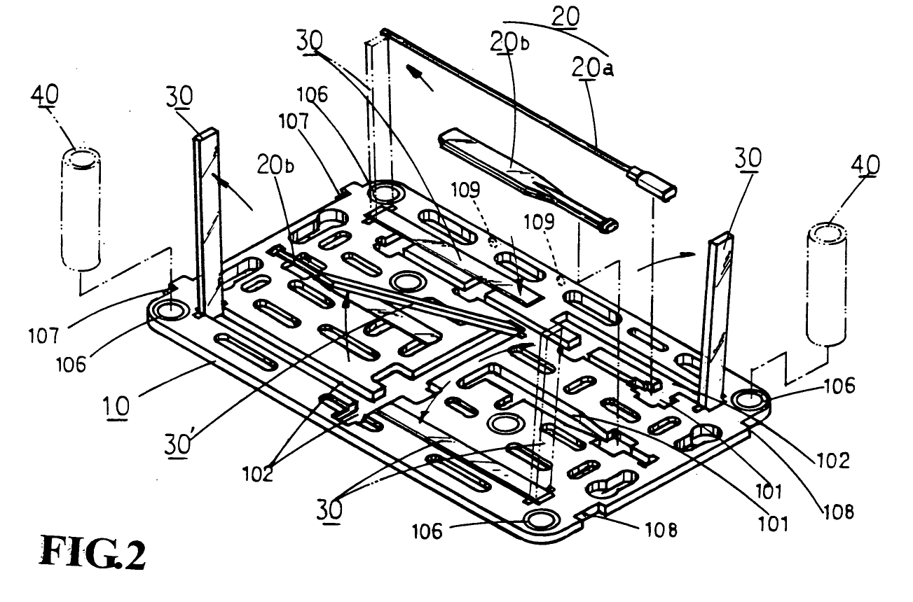

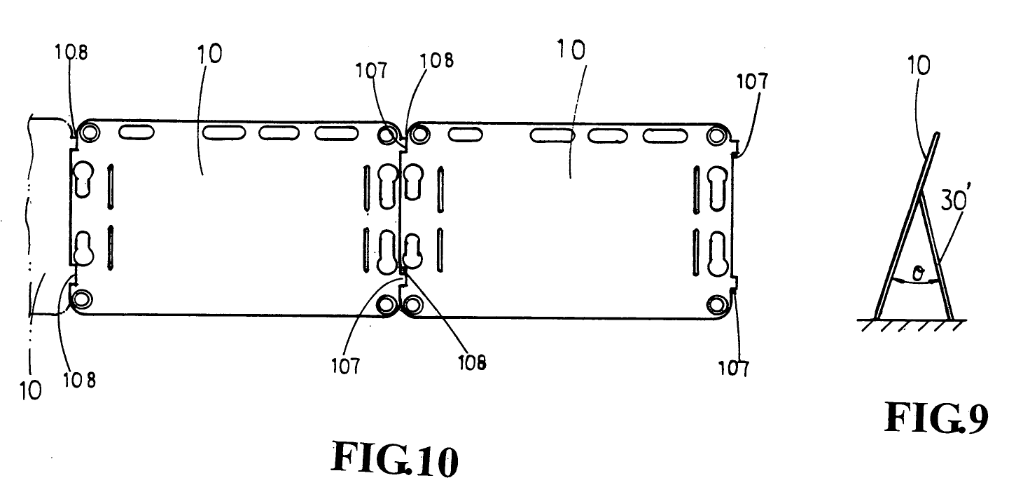

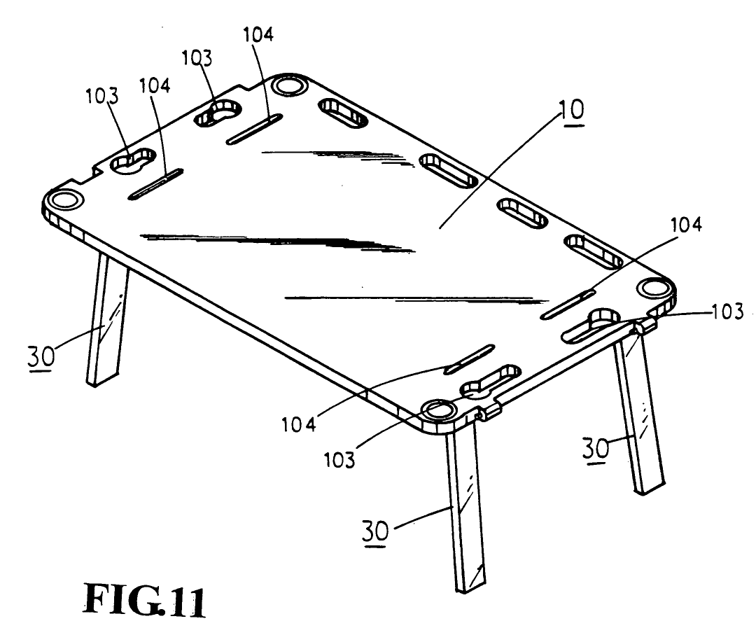

In FIGS. 9 and 10, the board body 10 includes a foldable and extendable leg 30 disposed at a back side of the board body 10, so that the invention can be used in an embodiment of folding the leg 30 to provide a board body 10 that is portable, transportable, easy-to-store, simple, and not occupying much space. Particularly, when the leg 30′ is extended outward to an appropriate angle θ (as shown in FIGS. 1 and 9), the board body 10 can be erected to serve as a billboard. Since both lateral sides of the board body 10 are engaged with the male and female latches 107, 108, therefore we can connect a plurality of board bodies 10 serially with each other, and each board body 10 of the respective leg 30′ can be extended open, so that the board bodies 10 can be converted directly into another form of a fence or a billboard. Of course, an end of the board body 10 has a water injecting hole 109 (as shown in FIG. 2), such that when the board body 10 is operated as a fence or a billboard, we simply need to inject water into the hollow accommodating portion A through the water injecting hole 109, and the board body 10 can be erected naturally to give a better stability.

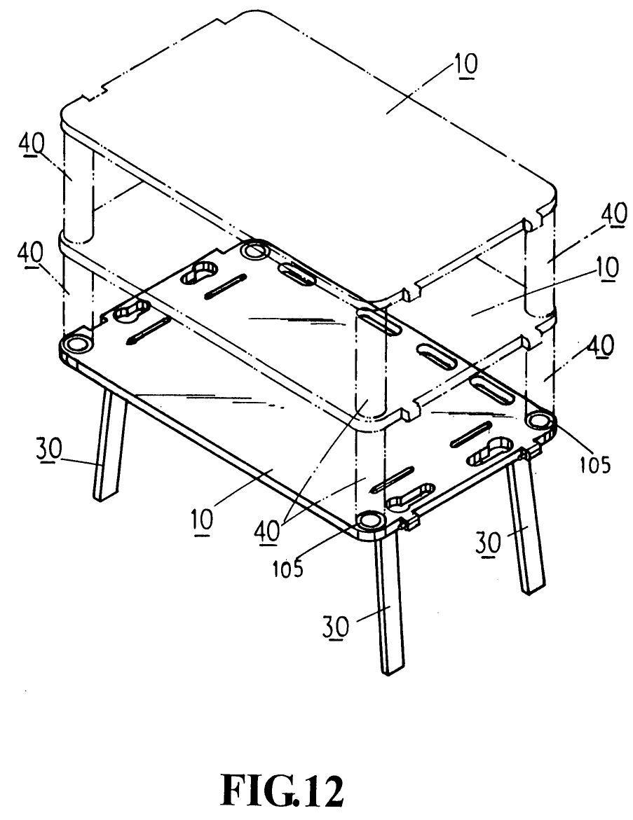

In FIG. 11, the board body 10 includes a cup slot 103 and a containing slot 104 disposed at the periphery of the front side of the board body 10 and the legs 30 installed at the back side of the board body 10 and can be extended into a desk form, so that the board body 10 of the invention can be uses as a leisure table or a desk with a simple operation. In FIG. 12, the board body 10 includes an embedding slot 105, 106 disposed separately at a position corresponding to the front and back sides of the four corners of the board body 10 for inserting and positioning the support pillar 40, such that a plurality of board bodies 10 can be stacked to form a multilayer storage cabinet by the operation of inserting and positioning each support pillar 40 and each leg 30.

In summation of the description above, the board for pasturage in accordance with a preferred embodiment of the present invention at least has the following advantages:
1. The board comes with a simple manufacture and an economic effect.
2. The board can be combined with a pasturage equipment to make the operation of the board for pasturage more convenient and efficient.
3. The board is easy-to-assemble, easy-to-use, convenient, portable, transportable, and not occupying much space.
4. The scope of applicability of the board is broad and diversified.

What is claimed is:

1. An improved board for pasturage, characterized in that a plurality of pasturage tool positioning slots are disposed on a back side of a board body, and a pasturage equipment is embedded and coupled to into the pasturage tool positioning slot.

2. The improved board for pasturage of claim 1, wherein the board body includes a plurality of cup slots and containing slots disposed on a front side of the periphery of the board body.

3. The improved board for pasturage of claim 1, wherein the board body includes a hollow accommodating portion formed thereon.

4. The improved board for pasturage of claim 1, wherein the board body includes a plurality of water injecting holes disposed on a lateral side of the board body, and penetrating through the hollow accommodating portions of the board body.

5. The improved board for pasturage of claim 1, wherein the board body includes an embedding slot disposed separately at positions corresponding to four corners of front and back sides of the board body, and a conical joint disposed at the center and tapered outward.

6. An improved board for pasturage, characterized in that a plurality of pasturage tool positioning slots and leg positioning slots are disposed on a back side of a board body for embedding and coupling corresponding pasturage equipment and leg of the pasturage equipment, and male and female latches disposed on both lateral sides of the board body for engaging and coupling the board body, and an embedding slot is disposed separately at positions corresponding to four corners of front and back sides of the board body for embedding and inserting a support pillar.

7. The improved board for pasturage of claim 6, wherein the leg has an end swung up and down and pivotally connected to a positioning slot of the leg of the board body, and another end swung up and down for being selectively folded and hidden into the leg positioning slot and extended and erected on a floor.

8. The improved board for pasturage of claim 6, wherein the board body includes a plurality of cup slots and containing slots disposed on a front side of the periphery of the board body.

9. The improved board for pasturage of claim 6, wherein the board body includes a hollow accommodating portion formed thereon.

10. The improved board for pasturage of claim 6, wherein the board body includes a plurality of water injecting holes disposed on a lateral side of the board body, and penetrating through the hollow accommodating portions of the board body.

11. The improved board for pasturage of claim 6, wherein the board body includes an embedding slot disposed separately at positions corresponding to four corners of front and back sides of the board body, and a conical joint disposed at the center and tapered outward.
